(19) United States
(12) Patent Application Publication
(10) Pub. No.: US 2004/0165268 A1
(43) Pub. Date: Aug. 26, 2004

(54) Diffractive shaping of the intensity distribution of a spatially partially coherent light beam

(76) Inventor: Jari Turunen, Kontiolahti (FI)

Correspondence Address: SWIDLER BERLIN SHEREFF FRIEDMAN, LLP, 3000 K STREET, NW, BOX IP, WASHINGTON, DC, 20007, US

(21) Appl. No.: 10/483,558

(22) PCT Filed: Jul. 16, 2001
(86) PCT No.: PCT/FI01/00673

(51) Int. Cl. G02B 5/18; G02B 27/42

(52) U.S. Cl. 359/558

(57) ABSTRACT

A new method is introduced to shape the intensity distribution and improve the quality of a beam emitted by a spatially partially coherent source with the aid of a periodic diffractive optical element (704). Periodic diffractive elements are not suitable for shaping spatially coherent light fields in the sense described in the invention because of the appearance of strong constructive interference effects, but the partial spatial coherence of light fields emitted by multimode sources suppresses these effects. The invention can be applied to shaping of intensity distributions emitted by lasers, light-emitting diodes, or optical fibers either, at a finite distance from the source (703) or in the far field. The invention is particularly advantageous in the shaping and quality improvement of beams emanating from high-power excimer lasers, semiconductor lasers, resonance-cavity light-emitting diodes, or arrays of lasers or light-emitting diodes (702, 705).

The invention relates to the shaping and quality-improvement of the intensity distributions of fields emitted by multimode lasers and other spatially partially coherent light sources.

Many high-power lasers commonly used in the industry, including pulsed excimer lasers, radiate light that consists of a large number of mutually uncorrelated transverse cavity modes. Light emitted by such sources is spatially partially coherent, unlike light emitted by usual Helium-Neon lasers or semiconductor diode lasers. Multimode lasers can therefore be considered as primary sources of spatially partially coherent light [F. Gori, Opt. Commun. 34, 301 (1980); A. Starikov ja E. Wolf, J. Opt. Soc. Am. 72, 923 (1982); S. Lavi, R. Prochaska and E. Keren, Appl. Opt. 27, 3696 (1988)].

The intensity distribution of a laser beam across a plane perpendicular to the propagation direction is an important property in nearly all industrial applications of lasers. For example, the beam shape of a pulsed excimer laser is typically far from ideal: sharp intensity fluctuations can be observed, the beam is not rotationally necessarily symmetric but strongly elliptic, and the intensity distribution may vary from pulse to pulse.

Typically, though not always, the far-field distribution of a multimode laser beam is, to a good approximation, of the same Gaussian form as the far-field distribution of a single-mode laser. The fundamental difference, however, is that the multimode beam is far from being diffraction-limited, i.e., its spread is larger than that of a single-mode beam with the same wavelength and initial size. In addition, a propagating multimode high-power laser beam often exhibit strong local intensity fluctuations not seen in high-quality single-mode laser beams.

A Gaussian intensity distribution is not always ideal. In many laser applications one prefers an intensity distribution, which is uniform within a certain region, such as a circle or a square, at a plane perpendicular to the propagation direction. For example, square-shaped beams are desirable in laser beam of patterns consisting of square pixels, while circular-shaped uniform beams are useful in laser drilling of different materials. Other shapes are useful as well: in laser fusion experiments a spherical object is illuminated by beams arriving from different directions, and in the optimum case each beam should illuminates a half-sphere uniformly. This requires a circular beam with the intensity distribution growing according to a cosine law from the center towards the edged and finally drops rapidly to zero.

The beams emanating from high-power edge-emitting semiconductor lasers also often consists of a large number of transverse modes. The special feature of these lasers of the the beam is spatially partially coherent in the direction of the light-emitting waveguide but (nearly) coherent in the opposite direction. Typically the beam quality is poor in the direction of the waveguide: strong local oscillations are observed, which one wishes to smooth out.

Bright semiconductor light sources not based on pure stimulated emission are also under development. One example is the resonant-cavity light-emitting diode (RC-LED), which is an intermediate for between a laser and a light-emitting diode (LED). The emitted radiation consists of a large number coherent cavity modes, an the superposed field is globally incoherent, or quasihomogeneous. When such a source is placed in the front focal plane of a positive lens, a partially coherent, quasi-collimated light fields is obtained, but the intensity distribution in, e.g., the far field is not ideal. Very often the beam is collimated (imaged) with a lens such that the far-field (image-plane) intensity distribution is approximately the image of the source surface. By approximately we mean that the lens aperture cuts off the high spatial frequencies in the angular spectrum of the primary field. Therefore a low-pass-filtered image is obtained, which usually does not have the desired form. Also the beam emanating from the end face of a multimode optical fiber is a spatially partially coherent field, which other requires shaping.

When aiming at high optical output power, especially with semiconductor light sources, it is customary to replace a single source with a one-dimensional or two-dimensional array of individual, mutually uncorrelated sources (lasers or LEDs). In that case an array of light spots appears in the image plane of a lens, even though one would prefer a uniformly illuminated region.

The task of shaping the intensity distribution of a coherent light beam either in the far field or at some finite distance from the source can in principle be performed using tradiational refractive optics: one places an aspheric refractive surface in front of the source, the surface shape being optimized such that the energy distribution in the target plane is of the desired form [P. W. Rhodes and D. L. Shealy, Appl. Opt. 19, 3545 (1980)]. In the obtained surface is rotationally symmetric, it can be fabricated for example by the diamond turning technique. If the refractive surface is not rotationally symmetric, its fabrication using present-day technology is difficult. On the other hand, even though one could fabricate the surface accurately, the function of the element remains sensitive to both the form of the incident intensity distribution and the alignment of the optical axes of the incident beam and the element (Drawing 1). The reason for this is that surface shape is: optimized on the basis of geometrical optics, which implies that a local change of the intensity distribution at the element plane has a direct local effect in the intensity distribution in the observation plane.

Diffractive optics [J. Turunen and F. Wyrowski, eds., Diffractive Optics for Industrial and Commercial Applications (Wiley-VCH, Berlin, 1997), in the following “Diffractive Optics”] has proved to be an excellent solution to many coherent laser beam shaping problems: an originally Gaussian intensity profile can be transformed into an almost arbitrary (for example, uniform or edge-enhanced) intensity distribution in the far field or at a finite distance by inserting on the beam path a surface-microstructured globally flat element, which modulates the phase, the amplitude, or both (“Diffractive Optics”, chapter 6). Diffractive optics offers a solution also the realization of above-mentioned rotationally nonsymmetric intensity distributions: since the microstructure is fabricated by microlithogrphic technology, the spefici form of the microstructure is not important from fabrication point of view. Nevertheless, the optical function of the element is still be analogous with that of an aspheric lens, so the problems with the sensitivity of the output profile to variations in the incident intensity distribution or alignment of the optical axes do not disappear. In diffractive optics it is possible to reduce the effects of these errors by including in the microstructure some controlled scattering, but the price to be paid is a reduction of conversion efficiency (“Diffractive Optics”, chapter 6).

The starting point of the design of conventional diffractive beam shaping elements is the assumption of perfect spatial coherence [W. B. Veldkamp ja C. J. Kastner, Appl. Opt. 21, 879 (1982); C.-Y. Han, Y. Ishii ja K. Murata, Appl. Opt. 22, 3644 (1982); M. T. Eisman, A. M. Tai ja J. N. Cederquist, Appl. Opt. 28, 2641 (1989); N. Roberts, Appl. Opt. 28, 31 (1989)]. Even though no laser fulfills this assumption perfectly, it is sufficient for all those lasers that emit radiation in essentially one transverse mode, even trough there were several longitudinal modes (i.e., the radiation is not perfectly monochromatic). However, the assumption of perfect spatial coherence fails if more than one transverse Nodes are present simultaneously. In this case the above-mentioned prior-art solutions do not necessarily work, and certainly the problems with beam shape variations and alignment tolerances remain.

U.S. Pat. No. 4,410,237 represents prior art in shaping fully coherent laser beams. The assumed diffractive structure is non-periodic. U.S. Pat. No. 6,157,756 represents prior art in shaping a fully coherent laser beam into a laser line with a large divergence angle. Tie fiber grating is periodic, but not microstructred, and its operation does not rely on partial coherence.

U.S. Pat. No. 4,790,627 discloses a method to shape spatially incoherent, wideband laser beams in laser fusion experiments. The main goal is to reduce the aberrations of the laser system using a shape-variant absorber and pattern projection. U.S. Pat. No. 4,521,675is concerned with essentially the same problem, but discloses a method that involves echelon gratings to convert a spatially coherent wideband bam into a wideband but essentially spatially incoherent beam.

This invention discloses a method to shape intensity distributions of multimode optical fields using diffractive optics [“Diffractive Optics”]. The invention is based on essentially periodic diffractive elements and the use of the partial spatial coherence of a multimode beam, i.e., in a property of light that was previously considered a problem.

The invention solves the above mentioned problems of prior art. It is characterized in that the shape of the transformed intensity distribution is independent, on the transverse alignment with respect to the incident bean and on reasonable deviations of the incident beam shape from the shape assumed in design. The partial spatial coherence is employed as disclosed below.

If two mutually fully correlated beams (for example beams obtained by splitting a single laser beam) are let to overlap, their complex amplitudes are summed. The intensity distribution is an interference pattern: if the beams are equally intense, fringes with bright maxima and zero-intensity minima are seen. If, on the other hand, two mutually uncorrelated beams (for example beams from two different lasers) are let to overlap, their intensity distributions are summed and no interference occurs. From the point of view of optical coherence theory, these two cases are the extremes, which are well known. Light emitted by multimode light sources do not fall into either one of them: if a multimode beam is divided into two parts and then recombined, an interference pattern is observed, but the visibility of the fringes reduces when the number of modes increases and the minima have non-zero intensity. In the invention we make use of this limited ability of spatially partially coherent light to interfere and apply it shape multimode light beams. The main idea is that the partial coherence of the incident field facilitates the use of periodic diffractive elements, which split the incident beam into several beams, in multimode beam shaping. This discovery may be viewed, in a sense, as an extension of the above-described observation on two-beam interference.

It is known that beams emitted by many multimode lasers can be characterized, to an adequate approximation, using the so-called Gaussian Schell model. The cross-spectral density function [L. Mandel and E. Wolf, Coherence and Quantum Optics (Cambridge University Press, Cambridge, 1995)] that describes the correlations of a Gaussian Schell-model source is of the form

W_{GSM}(x₁,x₂)=exp[−(x₁²+x₂²)/w₀²]exp[−(x₁−x₂)²/2σ₀²], (1)

where w₀ (the 1/e² half-width of the intensity profile) and σ₀ (the rms width of the desgree of coherence at the source plane) are constants and the global degree of coherence is described by the ration α=σ₀/w₀. The ratio α, and hence also σ₀, may be determined by measuring the far-field beam spread since the 1/e² far-field diffraction angle is obtained from θ=λ/(πw₀β), where λ is the wavelength of light and β=(1+α⁻²)^{-1/2} . Even though the Gaussian Schell-model is not precise for any real light source, it is sufficiently accurate for the purposes of this invention even for many such sources that do not have precisely Gaussian far-field diffraction patterns.

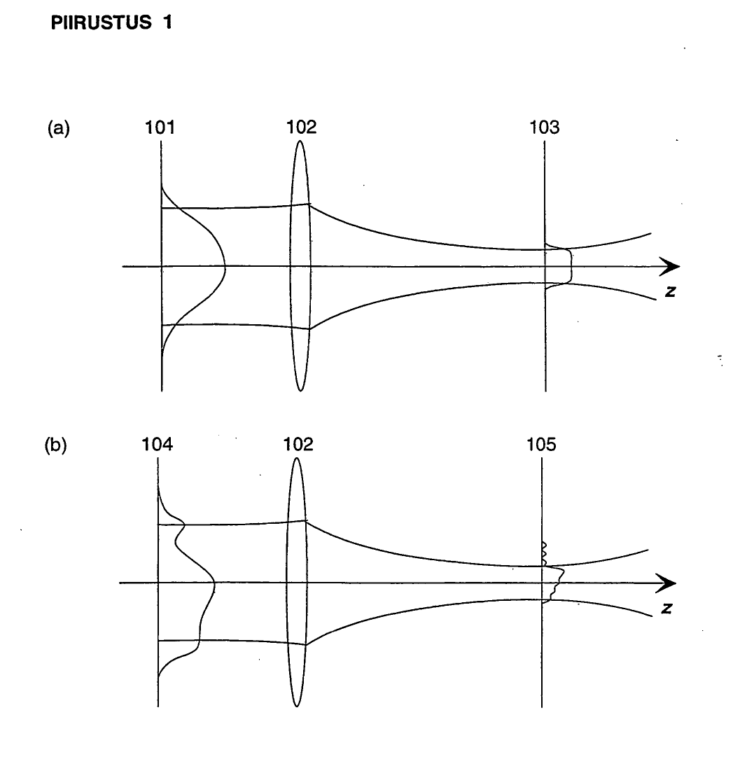

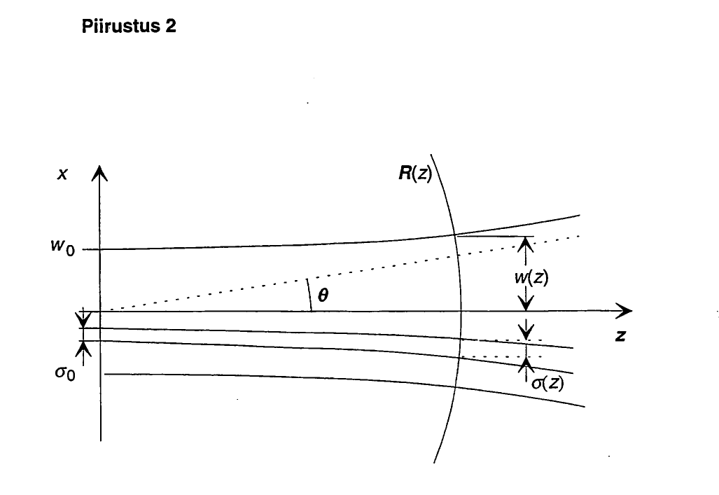

In the following we illustrate the invention by referring to FIGS. 2-8.

FIG. 2 illustrates the propagation of a Gaussian Schell-model beam in free space (or in a homogeneous dielectric). It illustrates the quantities w₀ and σ₀ and represents graphically the so-called propagation parameters, i.e., the 1/e² half-width w(z), the, coherence width σ(z), and the radius of curvature R(z). These quantities are known [A. T. Friberg ja R. J. Sudol, Opt. Commun. 41, 297 (1982)] to be given by

w(z)=w₀[1+(λz/πw₀²β)²]^{1/2}, (2)

σ(z)=αw(z), (3)

R(z)=z[1+(πw₀²β/λz)²]. (4)

The angle θ in FIG. 2 is the above mentioned 1/e² half width of the far-field intensity distribution. Upon passing through a thin lens a Gaussian Schell-model beam behaves as a spherical wave with a radius of curvature R(z).

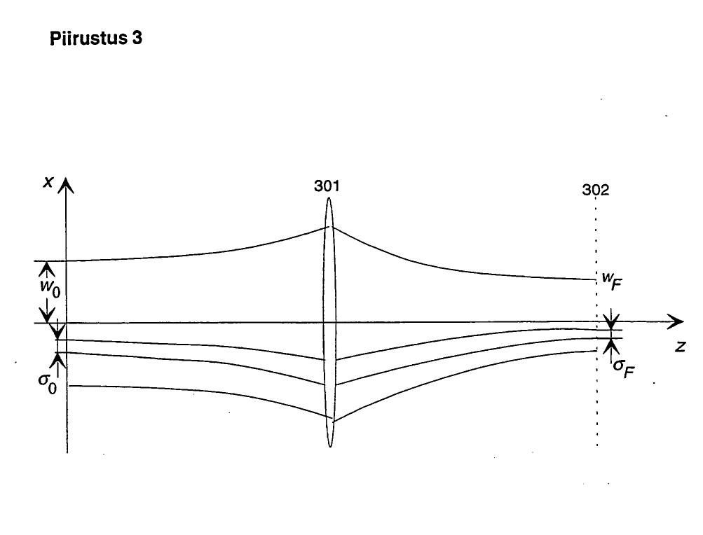

FIG. 3 illustrates a situation, in which a Gaissian Schell-model source is Fourier-transformed with a thin lens 301 (focal length F) in the standard 2F Fourier-transform geometry into the plane 302, where R(F)=∞, i.e., the wave front is planar. The use of equations (1)-(3) allows us to govern also this geometry by searching for Fourier-plane values of the beam and coherence widths is such a way the beam width and coherence area match with those of the incident beam at the plane of the lens. Using in addition the known law of spherical-wave transformation by a thin lens, one can find the output beam parameters. The procedure can be extended to propagate the Gaussian Schell-model beam though an arbitrary paraxial lens system [A. T. Friberg ja J. Turunen, J. Opt. Soc. Am. A 5, 713 (1988)].

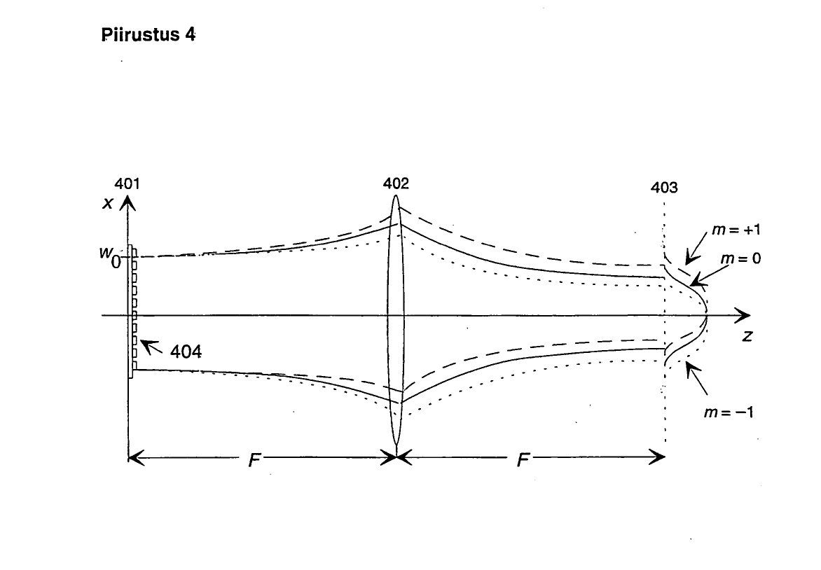

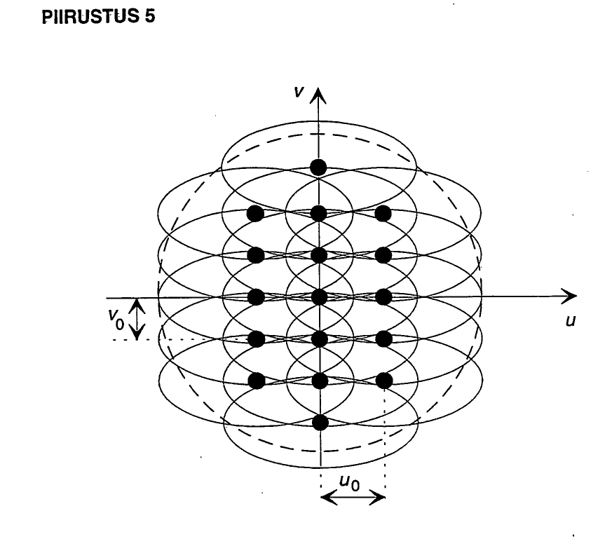

FIG. 4 illustrates a geometry in which a Gaussian Schell-model beam hits a periodic diffractive element, which splits a plane wave into a number of beams propagating in slightly different directions. The element is periodic in one or two directions and, as an ordinary diffraction grating, it produces diffraction orders with propagation directions given by the grating equation. The grating periods dₓ and d_{y} in x and y directions are typically chosen such that the separations δθₓ≈λ/dₓ and δθ_{y}≈λ/d_{y} are less than the far-field divergence angles θₓ and θ_{y} in x and y directions. In this manner we obtain a set of partially overlapping Gaussian Schell-model beams (FIG. 5) centered around the propagation directions of the diffraction orders. Unlike coherent beams, these Gaussian Schell-model beams interfere only partially, as we show in what follows. For simplicity we consider a two-dimensional geometry, but this can easily be extended to three dimensions.

Let us denote complex amplitudes associated with the diffraction orders at the exit plane of the diffractive element by Tₘ, where mεM is the index of the diffraction order and M is the set of those order whose diffraction efficiencies ηₘ=|Tₘ|² are significantly above zero. The cross-spectral density of the field immediately after the element is then

$$W ( {x}_{1} , {x}_{2} ) = {W}_{GSM} ( {x}_{1} , {x}_{2} ) {\sum }_{( m , n ) ∈ M} {T}_{m}^{*} {T}_{n} exp [ - ⅈ2π ( {mx}_{1} - {nx}_{2} ) / d ] , \qquad ( 5 )$$

where n is also an index denoting the diffraction order and d is the grating period in x direction. The intensity distribution in the focal plane of a lens (focal lengths F), where the position coordinate is denoted by u, is obtained from

$$I ( u ) = \frac{1}{λ F} \int {\int }_{- ∞}^{∞} W ( {x}_{1} , {x}_{2} ) exp [ ⅈ2π ( {x}_{1} - {x}_{2} ) u / λ F ] ⅆ {x}_{1} ⅆ {x}_{2} . \qquad ( 6 )$$

Integration using equations (1), (5) and (6) gives the final result

$$\begin{matrix}I ( u ) = \frac{{w}_{0}}{{w}_{F}} {\sum }_{( m , n ) ∈ M} {T}_{m}^{*} {T}_{n} exp \{ - [ ( u + \\ { m {u}_{0} )}^{2} + {( u + n {u}_{0} )}^{2} ] / {w}_{F}^{2} \} exp [ - {( m - n )}^{2} {u}_{0}^{2} / 2 {σ}_{F}^{2} ] ,\end{matrix} \qquad ( 7 )$$

where w_{f}=λF/πw₀β, σ_{F}=σ₀w_{F}/w₀ ja u₀=λF/d.

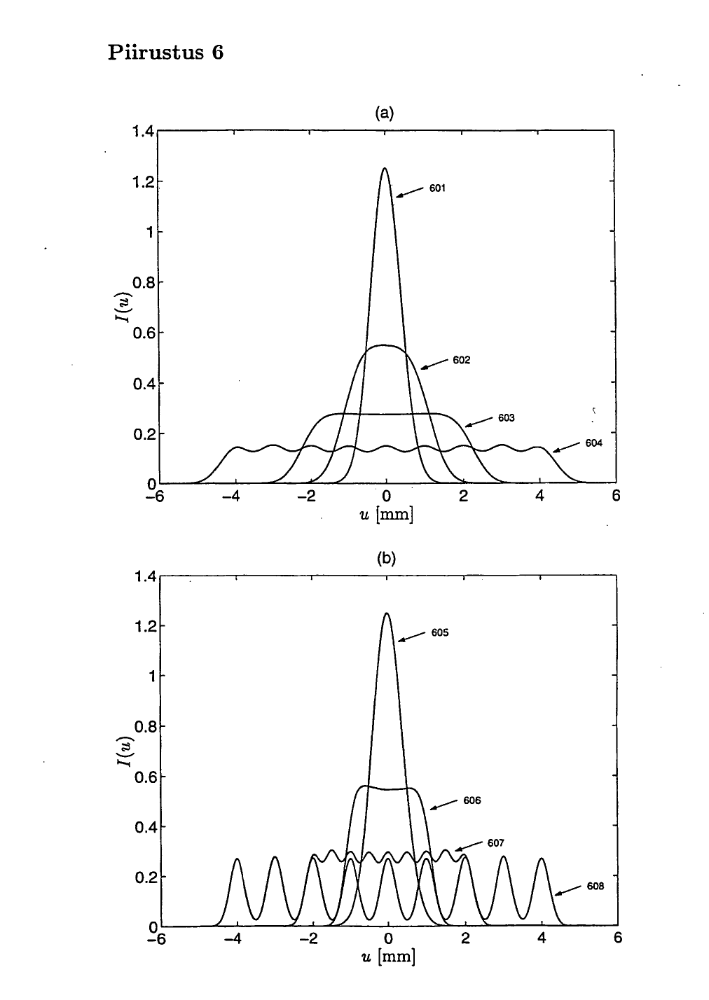

FIG. 6 illustrates numerical simulations based on equation (7) for the intensity distributions at the plane 302 of FIG. 3. The goal is to transform an originally Gaussian intensity distribution into a distribution with a flat top by using a diffractive element that would transform a fully coherent plane wave into nine equal-efficiency diffraction orders m=−4, . . . ,+4. The degree of coherence is α=1/5 in FIG. 5a and α=1/10 in FIG. 5b. These are rather typical values for excimer lasers. The other parameters are w₀=1 mm, F=1 m, λ=250 nm, and the grating period d is varied in FIG. 5 to find an optimum ratio w₀/d for each value of α.

When d is sufficiently large, the angular distance δθ between the orders is much less that the divergence angle θ, and at the same time u₀<<w_{F}. In this limit the far-field intensity distribution is barely influences by the element. When d is reduced, the Fourier-domain distribution spreads first and then divides into resolved peaks when w_{F}>u₀. With a suitable choice of d (or, more accurately, the ratio w₀/d) an optimum situation is obtained, in which the intensity distribution has the best uniformity. The optimum is d≈1 mm in FIG. 5a and d≈0.5 mm in FIG. 5b, i.e., a reduction in the degree of coherence reduces the optimum grating period because it increases the beam width w_{F}. It should be noted that the total energy is the same in all cases: reduction of d widens the beam while simultaneously decreasing its top intensity.

The period d is the most important tool influencing the beam shape (also the number of orders M has a smaller influence). It is of advantage to optimize d:separately in x and y directions whenever the source is anisotropic, i.e., its intensity distribution is periodic. FIG. 5 illustrates such a situation, observed in a plane perpendicular to the beam propagation direction. Because the source is anisotropic, so is its far-field diffraction pattern, but a proper choice of grating periods in x and y directions transforms the far-field pattern into a rotationally symmetric shape. If necessary, a different number of beams may be used in the two orthogonal directions.

As illustrated in the numerical simulations of FIG. 6, an element capable of transforming a Gaussian beam into a uniform-intensity beam produces a set of Gaussian beams propagating in different directions corresponding to the diffraction orders. The angles between the orders as chosen to be a substantial fraction of θ but not so large that the orders would be resolved. The degree of partial coherence α determines the choice of Δθ/θ, and perform the optimization independently in each case on the basis of numerical simulations, finding a compromise between the uniformity and and the complexity of the diffractive structure. The same principle i applicable to the design of other beam shaping elements, including edge-enhanced patterns, by a suitable choice of the efficiencies of individual orders. For the sake of clarity we have considered mostly one-dimensional signal patterns, but two-dimensional far-field patterns defined by can be obtained by a straightforward extension of the concepts presented above.

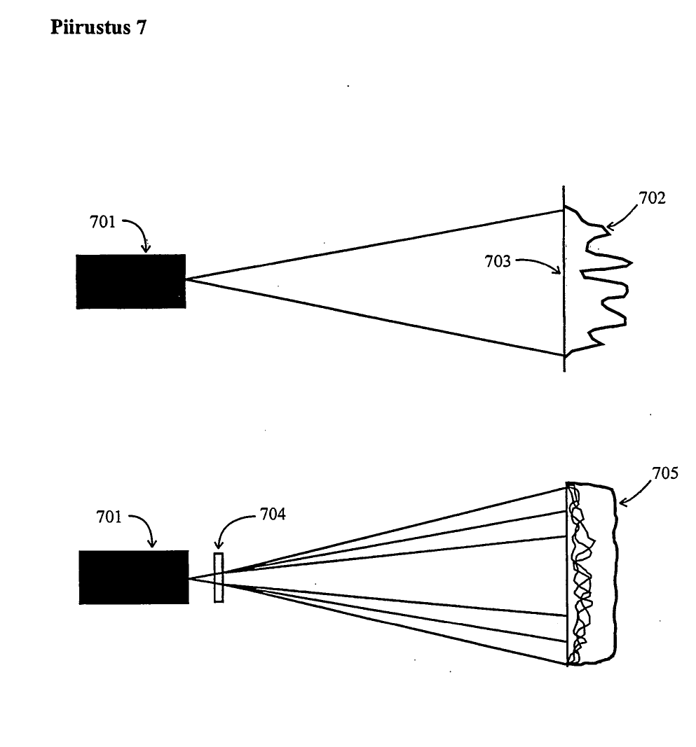

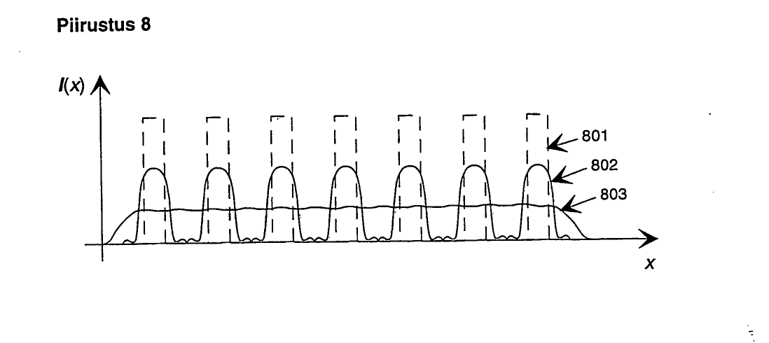

FIGS. 7 and 8 illustrate, by means of examples, certain other advantageous implementations of the invention and their applications.

FIG. 7 illustrates qualitatively the homogenization of a beam with strong, rapidly varying intensity distributions. Here the partially coherent beam is divided into several beams that propagate into slightly different directions such that its intensity distribution does not spread appreciably, and the beams interfere only partly. Therefore the intensity fluctuations tend to average out and the superposed beam is more homogeneous than the original beam. The method is suitable, for example, in improving the quality of individual excimer laser pulses and to obtain a better pulse-shape repeatability. It is also suitable for the homogenization of multimode semiconductor laser beams (as illustrated in FIG. 6).

FIG. 8 illustrates the imaging of several discrete, mutually uncorrelated light sources into the observation plane. The sources may be either lasers or LEDs. If the imaging lens is diffraction-limited and does not appreciably truncate the angular spectra of the sources, we obtain an image (801) of the source array. In practice a slightly wider distribution (802) is obtained. However, often one prefers a more or less continuous intensity distribution instead of a discrete array, for example a square or a rectangular uniformly illuminated region. This can be achieved by methods presented in the invention: the image of each source is multiplied in x and y directions such that the empty spaces between the discrete sources are filled. The images of different sources may overlap because the sources are mutually uncorrelated. Thus no interference is produced and the result is an incoherent sum of different intensity distributions (803).

### DRAWINGS

Drawing 1: Prior art. The intensity distribution of the laser beam (101) is shaped with the aid of an aspheric lens (102) such that the desired distribution arises at the plane (103). (a) Ideal situation: a Gaussian, perfectly aligned beam (101) produces a fiat-top intensity distribution at the focal plane (103) of the lens. (b) Practical situation: a deviation from the assumed intensity distribution of the incident beam or an alignment error (104) leads to undesired distortions in the final intensity distribution (105).

Drawing 2: Propagation of a Gaussian Schell-model beam in free space. w(z) is the 1/e² half-width of the intensity distribution, σ(z) is the spatial coherence width of the beam, and R(z) is its radius of wave front curvature.

Drawing 3: Fourier transformation of a Gaussian Schell-model source by a thin lens (301) into the plane (302).

Drawing 4: Shaping of a Gaussian Schell-model beam by means of a thin lens (401) and a periodic diffractive element (403).

Drawing 5: Interference of spatially partially coherent beams in a geometry of the type illustrated in Drawing 3 if the grating produces a two-dimensional array of diffraction orders (the ellipses). The center points of the ellipses denote the spatial frequencies of the diffraction orders. After superposition these mutually partially correlated fields form an almost constant-intensity region within the shown circular area.

Drawing 6: A numerically simulated intensity distribution in the plane (302) of Drawing 3 assuming that the diffractive element divides the beam into nine equally intense parts; (a) σ₀=w₀/5 and (b) σ₀=w₀/10. Curves 601 and 605: d=10 mm. Curves 602 and 606: d=1 mm. Curves 603 and 607: d=0.5 mm. Curves 604 and 608: D=0.25 mm.

Drawing 7: Homogenization of a multimode semiconductor laser (701) beam with a diffractive beam splitter. (a) The intensity distribution (702) on the screen (703) is non-uniform. (b) The diffractive element (704) produces a set (here three for clarity) of beams propagating in slightly different directions. The intensity distributions of all individual beams is of the type (702) but the superposition of the spatially partially coherent beams produces a homogenized beam (705).

Drawing 8: Combination of several mutually uncorrelated light beams emitted by independent light sources into an approximately flat-top pattern in the image plane of the source.

1. A method to control the intensity distribution of a spatially partially coherent light field at a finite distance from the source or in the far field, characterized in that the element is periodic in one or two directions orthogonal to the propagation direction of the incident light field.

2. Element described in claim 1, characterized in that it is applicable to shaping the intensity distributions of multimode beams originating from lasers, light-emitting diodes, or optical fibers in a plane perpendicular to the propagation direction of the original light beam.

3. Element described in claims 1 and 2, characterized in that its translation in a plane perpendicular to the beam propagation direction has no essential effect in the shaped beam, provided that the incident beam fits entirely within the element area.

4. Element described in claims 1 and 2, characterized in that it can average out rapid intensity fluctuations of multimode laser beams and improve the repeatability of the pulse shape.

5. Element described in claims 1 and 2, characterized in that it is capable of shaping fields emitted by multimode lasers, light emitting diodes and multimode fibers into a uniform or other intensity distribution within a boundary at the plane perpendicular to the propagation direction. This plane may reside either in the far field or at a finite distance from the source.

6. Element described in claims 1 and 2, characterized in that it is capable of transforming fields emitted by arrays of mutually uncorrelated multimode lasers, light emitting diodes and multimode fibers into uniform-intensity or other form within a boundary at the plane perpendicular to the propagation direction.

7. Element described in claims 1 and 2, characterized in that it is capable of realizing uniform illumination of a half-spherical object.
